(19) United States
(12) Patent Application Publication
(10) Pub. No.: US 2018/0108333 A1
(43) Pub. Date: Apr. 19, 2018

(54) DRUMSTICK

(71) Applicant: Yo Han KIM, Gunpo-si (KR)

(72) Inventor: Yo Han KIM, Gunpo-si (KR)

(21) Appl. No.: 15/682,051

(22) Filed: Aug. 21, 2017

(30) Foreign Application Priority Data
Oct. 17, 2016 (KR) 20-2016-0005980

(51) Int. Cl. G10D 13/00

(52) U.S. Cl. CPC G10D 13/003

(57) ABSTRACT

Disclosed herein is a drumstick. The drum stick includes: a stick body; a grip rod formed in a cylindrical shape, configured so that a center portion thereof is disposed to come into contact with and to cross the stick body, and provided with a first insertion ring configured to receive the thumb of a drummer and to protrude downward from one side of the grip rod, and a second insertion ring configured to receive the index finger of the drummer and to protrude upward from the other side of the grip rod; and a pair of fastening bands configured to surround the stick body and the grip rod in an X form, and made of a flexible material. The stick body is elastically rotated in the circumferential direction of the outer circumferential surface of the grip rod by means of elastic force of the fastening bands.

### BACKGROUND

### 1. Technical Field

The present invention relates generally to a drumstick used for playing a drum, and more particularly to a drumstick which enables a stick body to be elastically moved along the outer circumference of a grip rod by means of fastening bands during the playing of a drum, thereby enabling playing through the performance of wrist snaps using small force and also facilitating the correction of grips.

### 2. Description of the Related Art

Generally, a drum is a percussion instrument which includes a set of components, including a snare, a base, tam-tams, cymbals, a hi-hat, etc., and is played through beating using a drumstick.

A drum requires specific fundamental playing methodology like other musical instruments. The process of learning basic positions related to a method of gripping a drumstick and a method of beating a drum with a drumstick must be essentially performed in order to play a drum. Even when a skill has been improved beyond a basic level, continuous practice must be performed in order to learn and maintain drumstick techniques.

Such a drumstick is formed in a rod shape having a predetermined length. A drummer plays a drum by beating the drum with such a drumstick while directly gripping one end of the drumstick.

However, when a drummer strongly beats a drum, such a drumstick bounces up and moves arbitrarily after the beating, and the hand of a drummer may lose contact with the drumstick.

Furthermore, it is very difficult for an unskilled beginner to maintain a correct drumstick gripping position while he or she is playing a drum alone. Moreover, the act of excessively bending and spreading the wrist of a drummer is repeated during fast bit playing, and thus pain may be caused in the wrist.

### PRIOR ART DOCUMENT

### Patent Document

Patent document 1: Korean Utility Model Registration Application Publication No. 2011-0007073

### SUMMARY

An object of the present invention is to provide a drumstick which enables a stick body to be elastically moved along the outer circumference of a grip rod by means of fastening bands during the playing of a drum, thereby enabling playing through the performance of wrist snaps using small force and also facilitating the correction of grips.

According to an aspect of the present invention, there is provided a drumstick, including: a stick body; a grip rod formed in a cylindrical shape, and configured so that the center portion thereof is disposed to come into contact with and to cross the stick body; and a pair of fastening bands configured to surround the stick body and the grip rod in an X form.

The grip rod may be provided with a first insertion ring configured to receive the thumb of a drummer and to protrude downward from one side of the grip rod, and a second insertion ring configured to receive the index finger of the drummer and to protrude upward from the other side of the grip rod.

The drumstick may further include a grip band configured to be inserted over the stick body near the grip rod and provided with a third insertion ring configured to receive the middle finger of the drummer and to protrude downward.

The pair of fastening bands may be made of a flexible material so that the stick body is elastically rotated in the circumferential direction of the outer circumferential surface of the grip rod during playing.

The drumstick may further include a pair of fastening bolts configured to pass through respective through holes formed at the intersections of the pair of fastening bands and to be respectively fastened to the stick body and the grip rod so that the pair of fastening bands are fastened to the stick body and the grip rod.

A plurality of adjusting holes configured to receive one of the fastening bolts so that a location of the pair of fastening bands is adjusted in a lengthwise direction may be formed in the stick body at predetermined intervals.

### BRIEF DESCRIPTION OF THE DRAWINGS

to The above and other objects, features and advantages of the present invention will be more clearly understood from the following detailed description taken in conjunction with the accompanying drawings, in which:

FIG. 1 is a perspective view schematically showing a drumstick according to a first embodiment of the present invention;

FIG. 2 is an exploded perspective view schematically showing the drumstick shown in FIG. 1;

FIG. 3 is an exploded perspective view schematically showing a drumstick according to a second embodiment of the present invention;

FIG. 4 is a perspective view schematically showing a drumstick according to a third embodiment of the present invention;

FIG. 5 is an exploded perspective view schematically showing the drumstick shown in FIG. 4; and

FIG. 6 is a view showing the operation of the drumstick shown in FIG. 4.

### DETAILED DESCRIPTION

Preferred embodiments of the present invention will be described in detail below with reference to the accompanying drawings. This description is intended to describe the present invention in detail so that a person having ordinary knowledge in the art to which the present invention pertains can easily practice the present invention, but is not intended to limit the technical spirit and scope of the present invention.

Throughout the accompanying drawings, portions unrelated to the description will be omitted in order to clearly describe the present invention, and identical or similar reference symbols will be assigned to identical or similar portions or components.

Furthermore, when a portion is described as “including” or “comprising” a component, this does not mean that the portion excludes another component but means that the portion may further include or comprise another component, unless specifically described to the contrary.

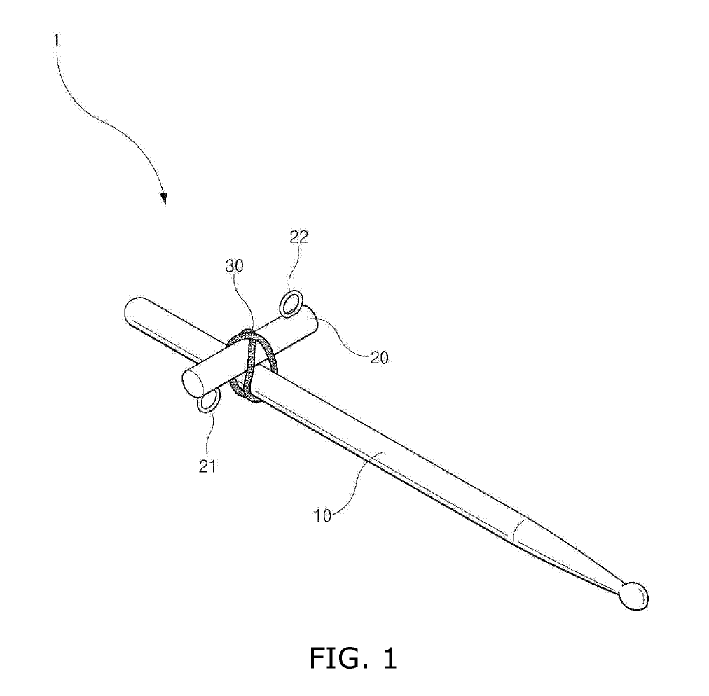

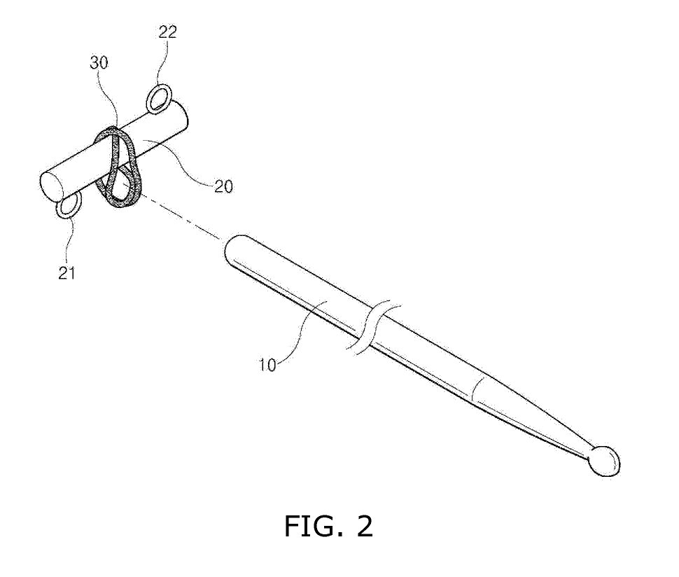

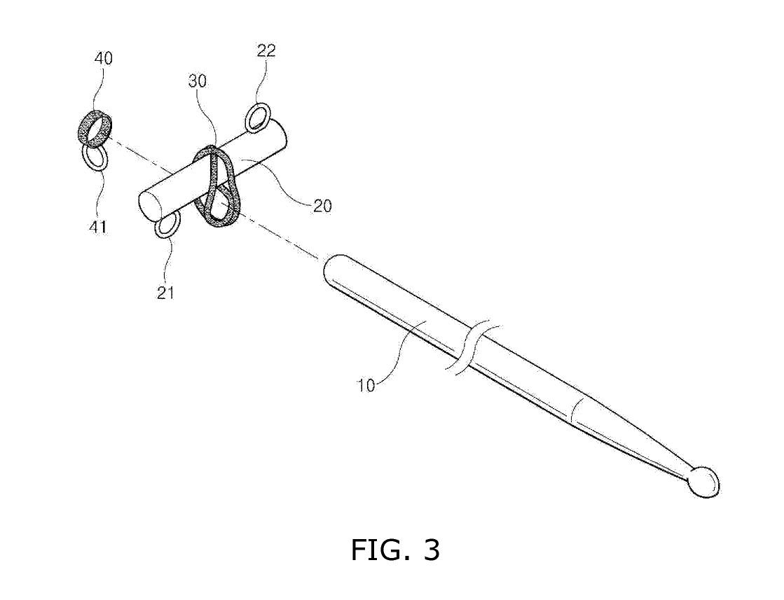

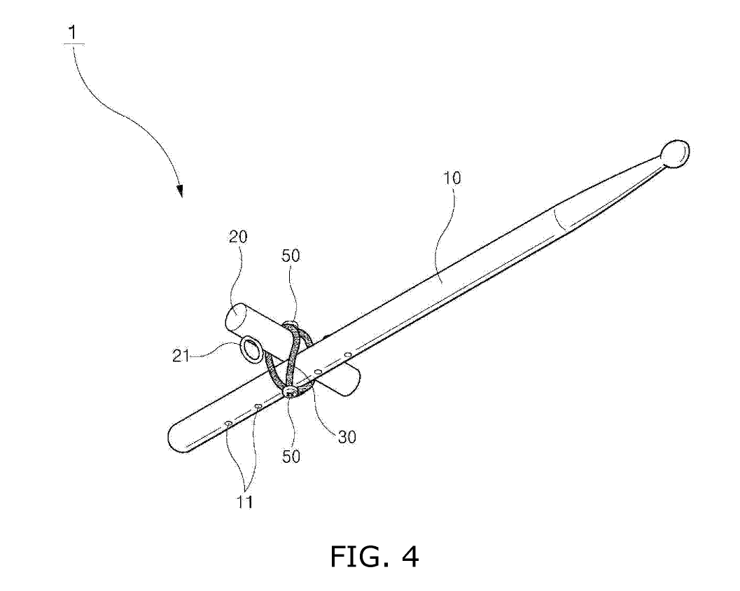

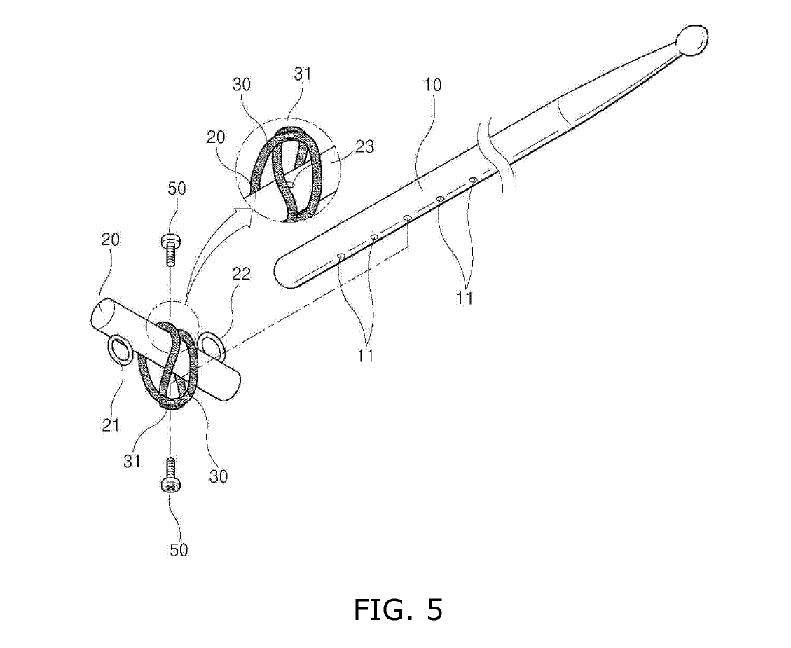

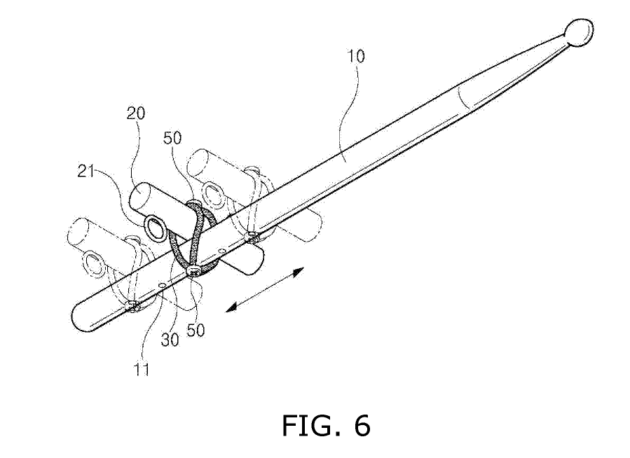

FIG. 1 is a perspective view schematically showing a drumstick according to a first embodiment of the present invention, FIG. 2 is an exploded perspective view schematically showing the drumstick shown in FIG. 1, FIG. 3 is an exploded perspective view schematically showing a drumstick according to a second embodiment of the present invention, FIG. 4 is a perspective view schematically showing a drumstick according to a third embodiment of the present invention, FIG. 5 is an exploded perspective view schematically showing the drumstick shown in FIG. 4, and FIG. 6 is a view showing the operation of the drumstick shown in FIG. 4.

As shown in FIGS. 1 to 6, a drumstick 1 according to each of the embodiments of the present invention includes: a stick body 10; a grip rod 20 formed in a cylindrical shape, and configured so that the center portion thereof is disposed to come into contact with and to cross the stick body 10; and a pair of fastening bands 30 configured to surround the stick body 10 and the grip rod 20 in an X form so that the grip rod 20 is coupled to the stick body 10 in the state of crossing the stick body 10.

In this case, the stick body 10 functions to be elastically moved by the fastening bands 30 when a drummer plays a drum and to beat a snare, tam-tams, and cymbals constituting the drum, and is not limited to a specific type of body. The stick body 10 may have the same material and the same shape as a typical stick body.

The grip rod 20 is disposed on the stick body 10 by means of the pair of fastening bands 30 so that the grip rod 20 crosses the stick body 10. The grip rod 20 is held by a hand of a drummer so that the stick body 10 beats a drum by means of a wrist snap when the drummer plays the drum.

Although the grip rod 20 may be formed in the shape of a polygonal rod having a predetermined length, the grip rod 20 is formed in a cylindrical shape so that the stick body 10 is elastically rotated along the outer circumferential surface of the grip rod 20 by the elastic force of the pair of fastening bands 30 when the stick body 10 beats the drum during playing.

In this case, although the drummer may elastically rotate the stick body 10 by means of a wrist snap in the state of holding the grip rod 20, there is concern about the loss of contact with the grip rod 20 during playing when the wrist is rapidly and strongly moved.

For this purpose, based on the center of the grip rod 20, a first insertion ring 21 configured to receive the thumb of a drummer is formed on one side of the grip rod 20, and a second insertion ring 22 configured to receive the index finger of the drummer is formed on the other side of the grip rod 20.

In this case, it is preferred that the first insertion ring 21 protrudes downward and the second insertion ring 22 protrudes upward so that when the thumb is inserted into the first insertion ring 21 and the index finger is inserted into the second insertion ring 22, the thumb supports the grip rod 20 and the index finger surrounds the grip rod 20.

Furthermore, when the first insertion ring 21 and the second insertion ring 22 are set to constant sizes and the sizes of the thumb and index finger of a drummer are larger or smaller than those of the first insertion ring 21 and the second insertion ring 22, a disadvantage arises in that the fingers are loosely inserted into or cannot be inserted into the first insertion ring 21 and the second insertion ring 22.

For this purpose, the first insertion ring 21 and the second insertion ring 22 are preferably made of a flexible material which can be selectively extended and contracted to be worn on the fingers regardless of the sizes of the fingers of a drummer.

Furthermore, the stick body 10 and the grip rod 20 are surrounded by the pair of fastening bands 30 in an X form. These fastening bands 30 function to couple the grip rod 20 to the stick body 10 so that the grip rod 20 is fastened onto the stick body 10.

In this case, if the pair of fastening bands 30 is made of a hard material like common cable ties, a drummer may play a drum by means of a wrist snap. However, in this case, the angle of the grip rod 20 crossing the stick body 10 cannot be changed, and thus a disadvantage arises in that a gripping sensation related to the grip rod 20 becomes poor.

Accordingly, the pair of fastening bands 30 are preferably made of a flexible material so that the angle of the grip rod 20 can be changed and the stick body 10 can be elastically rotated in the circumferential direction of the outer circumferential surface of the grip rod 20 by means of a wrist snap during the playing of a drum.

Accordingly, the stick body 10 is elastically moved along the outer circumference of the grip rod 20 by means of a weak wrist snap, and thus advantages arise in that during the playing of a drum, burden is not imposed on the wrist of a drummer and rapid bit playing is enabled.

Meanwhile, in some cases, a grip band 40 configured to be movable in the lengthwise direction of the stick body 10 and to come into tight contact with the grip rod 20 may be further included. The grip band 40 is provided with a third insertion ring 41 configured to receive the middle finger of a drummer.

In this case, it is preferred that the third insertion ring 41 protrudes downward so that the middle finger surrounds the lower portion of the stick body 10 when the middle finger is inserted into the third insertion ring 41.

Accordingly, when the middle finger of a drummer is inserted into the third insertion ring 41 in the state where the thumb and index finger of the drummer have been inserted into the first insertion ring 21 and the second insertion ring 22, respectively, advantages arises in that the grip rod 20 can be more stably held and contact with the grip rod 20 is not lost despite a rapid and strong wrist snap.

Furthermore, in some cases, as shown in FIGS. 4 to 6, a pair of fastening bolts 50 configured to pass through the intersections of the pair of fastening bands 30 and to couple the stick body 10 and the grip rod 20 to each other.

For this purpose, the stick body 10 is preferably provided with adjusting holes 11 configured to receive any one of the pair of fastening bolts 50 on the side of the stick body 10 opposite the side of the stick body 10 in contact with the grip rod 20, the grip rod 20 is preferably provided with a fastening hole 23 configured to receive the other one of the pair of fastening bolts 50 on the side of the grip rod 20 opposite the side of the grip rod 20 in contact with the stick body 10, and the pair of fastening bands 30 are preferably provided with through holes 31 configured to pass the pair of fastening bolts 50 therethrough at the intersections of the pair of fastening bands 30.

In other words, any one of the pair of fastening bolts 50 passes through one of the through holes 31 of the fastening bands 30 and is fastened into one of the adjusting holes 11 of the stick body 10, and the other one of the pair of fastening bolts 40 passes through the other one of through holes 31 of the fastening bands 30 and is fastened into the fastening hole 23 of the grip rod 20. As a result, the fastening bands 30 are fastened, and thus an effect is achieved in that the stick body 10 and the grip rod 20 are prevented from being separated from each other.

In this case, the adjusting holes 11 formed in the stick body 10 may be plural in number, and may be formed in the lengthwise direction of the stick body 10 at predetermined intervals.

In other words, as shown in FIG. 5, the location of the fastening bands 30 may be adjusted in the lengthwise direction of the stick body 10 based on the fastening location of the fastening bolt 50 which passes through one of the through holes 31 of the fastening bands 30 and is fastened to the stick body 10. Accordingly, an advantage arises in that the grip rod 20 can be located at a location where a drummer can easily play a drum with the drumstick.

As described above, according to the present invention, the grip rod is disposed to cross the stick body by means of the pair of fastening bands, and thus the stick body can be elastically moved along the outer circumference of the grip rod during the playing of a drum, thereby providing the advantages of strongly beating a drum through the performance of wrist snaps using small force during the playing of the drum and preventing burden from being imposed on the wrist of a drummer during fast beat playing.

Furthermore, the grip rod is provided with the first insertion ring and the second insertion ring configured to receive the thumb and index finger of a drummer, respectively, thereby providing the advantages of preventing contact with the stick body from being lost during the playing of a drum and enabling even a beginner to maintain a correct grip position.

Although the specific embodiments of the present invention have been disclosed for illustrative purposes, those skilled in the art will appreciate that various modifications, M additions and substitutions are possible without departing from the scope and spirit of the invention as disclosed in the accompanying claims.

What is claimed is:

1. A drumstick, comprising:
a stick body;
a grip rod formed in a cylindrical shape, configured so that a center portion thereof is disposed to come into contact with and to cross the stick body, and provided with a first insertion ring configured to receive a thumb of a drummer and to protrude downward from one side of the grip rod, and a second insertion ring configured to receive an index finger of the drummer and to protrude upward from a remaining side of the grip rod; and
a pair of fastening bands configured to surround the stick body and the grip rod in an X form, and made of a flexible material so that an angle of the grip rod can be changed; and
wherein the stick body is elastically rotated in a circumferential direction of an outer circumferential surface of the grip rod by means of elastic force of the fastening bands.

2. The drumstick of claim 1, further comprising a grip band configured to be inserted over the stick body near the grip rod, and provided with a third insertion ring configured to receive a middle finger of the drummer and to protrude downward.

3. The drumstick of claim 1, further comprising a pair of fastening bolts configured to pass through respective through holes formed at intersections of the pair of fastening bands and to be respectively fastened to the stick body and the grip rod so that the pair of fastening bands are fastened to the stick body and the grip rod.

4. The drumstick of claim 3, wherein a plurality of adjusting holes configured to receive one of the fastening bolts so that a location of the pair of fastening bands is adjusted in a lengthwise direction is formed in the stick body at predetermined intervals.
